(19) United States
(12) Patent Application Publication
(10) Pub. No.: US 2007/0186740 A1
(43) Pub. Date: Aug. 16, 2007

(54) Method and apparatus for forming and cutting vinyl tiles with rolled edges

(76) Inventors: Steven Dreyer, Ft. Lauderdale, FL (US); Ming-Shung Shih, Taipei (TW)

Correspondence Address: MALLOY & MALLOY, P.A., 2800 S.W. Third Avenue, Historic Coral Way, Miami, FL, 33129, US

(21) Appl. No.: 11/445,761

(22) Filed: Jun. 2, 2006

(30) Foreign Application Priority Data
Feb. 10, 2006 (TW) 095102540

(51) Int. Cl. D04H 11/00; B26D 7/06

(52) U.S. Cl. 83/129

(57) ABSTRACT

A press forming-and-cutting method and a related device are structured to produce vinyl tile with rolled edges. A press forming-and-cutting die and related mechanisms are structured to form and cut vinyl tile that has been rolled and surface-finished to produce an end-product of vinyl tile with rolled edges in a single integrated operation. The press forming-and-cutting die is driven by a hydraulic press system.

### CLAIM OF PRIORITY

The present application is based on and a claim to priority is made under 35 U.S.C. Section 119 to currently pending Taiwan patent application, namely, Taiwan patent application having Serial No. 095102540, filed on Feb. 10, 2006, entitled “CUTTING METHOD AND DEVICE OF THE PLASTIC TILE WITH EDGE CHAMFER.”

### BACKGROUND OF THE INVENTION

1. Field of the Invention

The present invention is generally directed to a forming-and-cutting method and device for producing vinyl tile with rolled edges, and more particularly, to a method and device to produce vinyl tiles with rolled edges in a single integrated operation.

2. Description of the Related Art

The method for cutting vinyl tiles generally uses a hydraulic press to directly press-cut vinyl tiles, as show FIG. 1. First, uncut vinyl tile 15 that has been rolled and embossed is put on a lower die 14, and a piston rod 11 driven by a hydraulic system pushes an upper die base plate 12 to press downward. A cutting die 13, screwed to the upper die base plate 12, is constructed with a blade seat 131 and four cutting tools 132 based on the size to be cut. The blade seat 131 screwed to the upper die base plate 12 and the four cutting tools 132 are screwed to the circumference of the blade seat 131. Therefore, as shown in FIG. 2(b), when the cutting die 13 presses downward, the cutting die 13 cuts the uncut vinyl tile 15 to produce vinyl tiles 16 of the size designated by the cutting die 13 and the lower die 14. The vinyl tiles 16 cut by this method do not have rolled edges, as shown in FIG. 2(c). In order to have the same level of pavement quality as ceramic tiles, the method for producing vinyl tiles with rolled edges generally comprises two steps: first, a blade is used to produce vinyl tiles without rolled edges 16, and second, a manufacturing process, such as milling and/or grinding, is used to produce the rolled edges of vinyl tiles. This process requires a lot of time and labor.

### SUMMARY OF THE INVENTION

The present invention aims to provide “a forming-and-cutting method and device for producing vinyl tiles with rolled edges”. The invention is generally a forming-and-cutting method and device for producing vinyl tiles with rolled edges, and more in particular, a method and device for producing vinyl tile with rolled edges in a single integrated operation.

### BRIEF DESCRIPTION OF THE DRAWINGS

FIG. 1 is a front view of a conventional press cutting machine;

FIG. 2(a) is a schematic drawing of the cutting die, the lower die plate and the tile plate for the conventional press cutting device;

FIG. 2(b) is a schematic drawing of the conventional cutting method of vinyl tile;

FIG. 2(c) is a drawing of end-product vinyl tiles produced from a conventional cutting method and device;

FIG. 3 is a construction drawing of a press forming-and cutting machine for producing vinyl tile with rolled edges in accordance with the present invention;

FIG. 4 is a schematic drawing of an upper die base plate, an upper press forming-and-cutting die, and a lower die of the press forming-and-cutting device for producing vinyl tile with rolled edges in accordance with this invention;

FIG. 5(a) is a construction drawing of a press forming-and-cutting die in accordance with this invention;

FIG. 5(b) is a section-drawing of the press forming-and-cutting die of FIG. 5(a) along lines A-A thereof;

FIG. 5(c) is a section-drawing of the press forming-and-cutting die of FIG. 5(a) along lines B-B thereof;

FIG. 5(d) is a construction drawing of a press-die face of a pressing-die in accordance with this invention;

FIG. 6 is a detailed structure drawing of a press forming-and-cutting die in accordance with this invention;

FIG. 7 is a press forming-and-cutting method and process for producing vinyl tile with rolled edges in accordance with the present invention; and

FIG. 8 is a drawing of end-product vinyl tiles of vinyl tile with rolled edges produced from the method and device in accordance with the present invention.

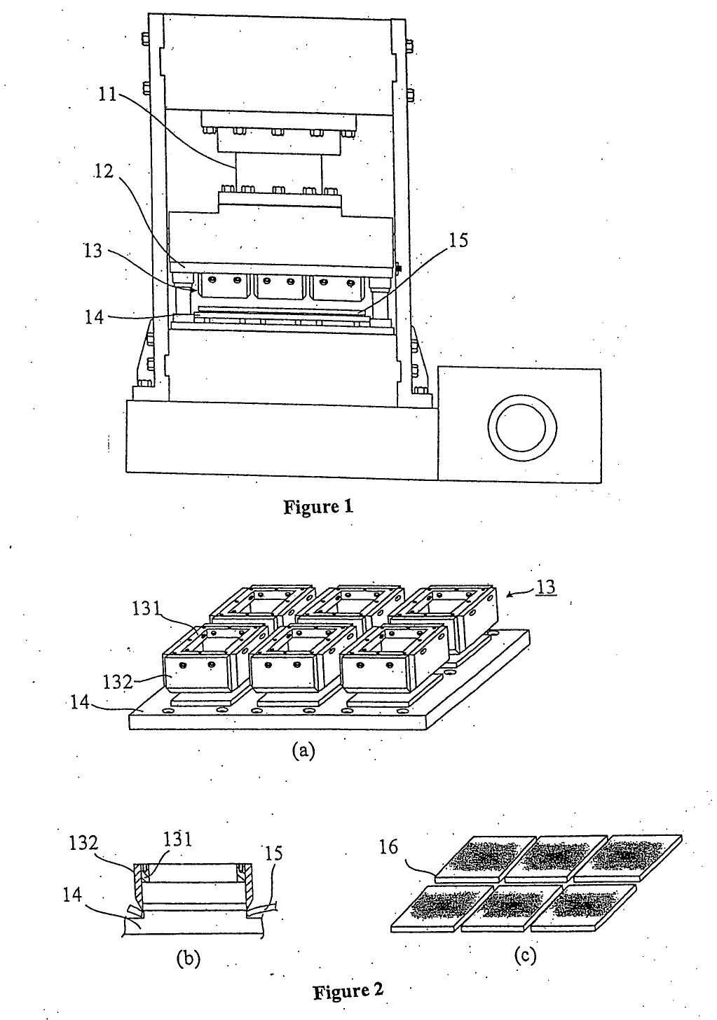

### DETAILED DESCRIPTION OF THE INVENTION

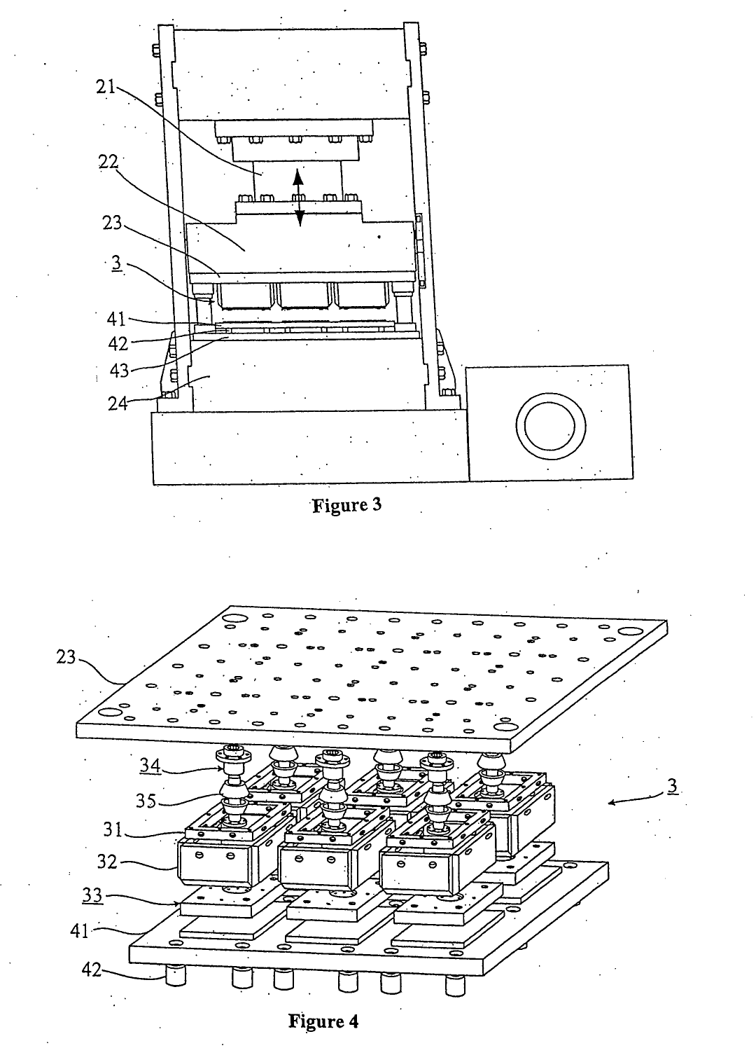

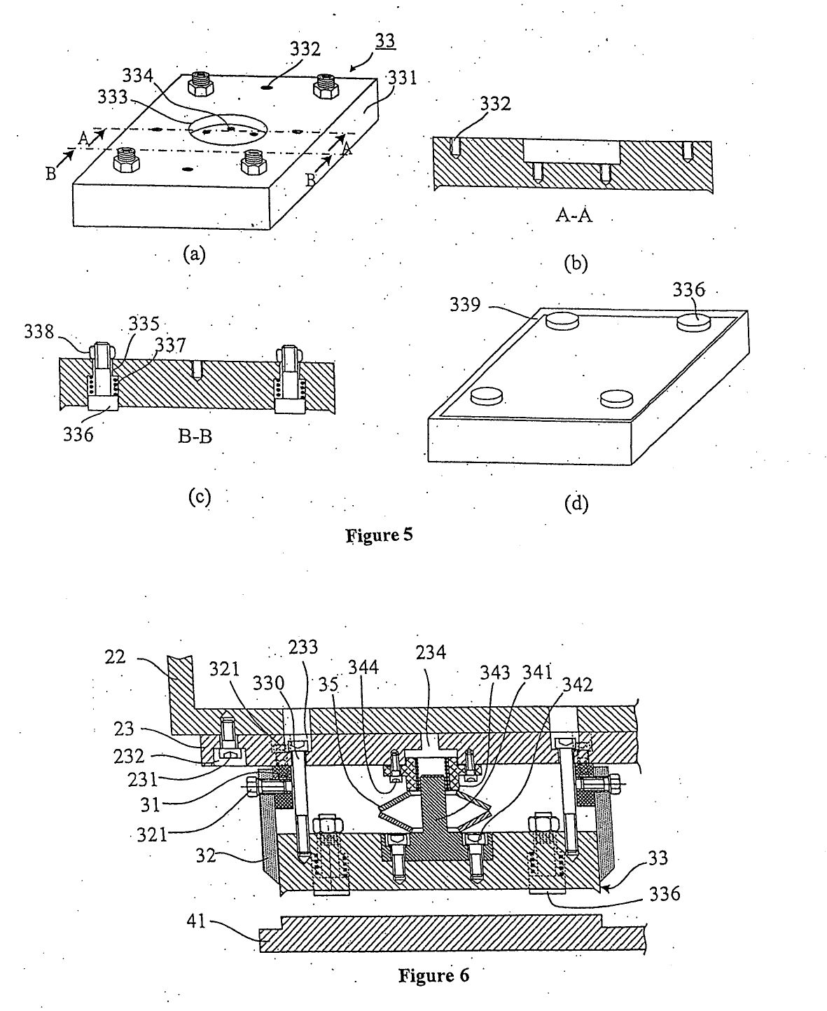

FIG. 3 is a construction drawing of the press forming-and-cutting machine for producing vinyl tiles with rolled edges in accordance with the present invention. This press forming-and-cutting device comprises mainly a hydraulic cylinder 21, an upper die bracket 22, an upper die base plate 23, an upper die base platform 24, an upper press forming-and-cutting die 3 and a lower die (including: lower die plate 41, damper 42, and lower die base plate 43). The upper press forming-and-cutting die 3 shown in FIG. 4 comprises mainly a blade seat 31, a blade 32, a press forming die 33, a linear bearing set 34 and a disk spring 35. The press forming die 33 shown in FIG. 5 comprises mainly the die plate 331 and the ejector device (including: ejector 336, ejector spring 337 and ejector nut 338). In FIG. 5(a), a cylindrical groove 333 is machined in the center of the plate 331, four threaded holes 334 are evenly distributed around the grooves, four bolt holes 332 for die hanging are machined at the center of four edges, and four spot-faced holes 335 are drilled in the four corners on the die plate 331. As shown in FIG. 5(c), the ejector devices (including: ejector 336, ejector spring 337 and ejector nut 338) are embedded in the spot-faced holes 335, where each ejector 336 is put through a corresponding spot-faced hole 335, is compressed against the ejector spring 337, and then is fixed by screwing to the ejector nut 338. In FIG. 5(d), outward-tilted triangular protruding slope 339 is used to produce rolled edges, and the length and slope of this triangular slope are the length and slope of the rolled edges.

Moreover, FIG. 6 shows the structure of the press forming-and-cutting die 3 designed in this invention. The round bar 341 of the linear bearing is mounted on the cylindrical groove 333 in the center of the die plate 331 by screwing to the threaded hole 334 with bolt 342. The slide block 343 of the linear bearing is mounted in the spot-faced hole 234 of the upper die base plate 23 by screwing with bolt 344. Thus the press forming die 33 can move vertically relative to the upper die base plate 23. Two disk springs 35, based on the force needed for pressing rolled edges, are mounted on the round bar 341. Four bolts 330, passing through the spot-faced holes 233 of the upper die base plate 23, are used to bolt these two disk springs 35 to the threaded hole 332 on the die plate 331. Thus the press forming die 33 is hanging under the upper die base plate 23 with a tension force of the disk spring 35. The blade seat 31 is bolted to the upper die base plate 23 with bolt 311 and then the blade 32 is screwed to the blade seat 31 with bolt 321 with the tips of the blade lower than the press forming die 33. The upper die base plate 23 with press forming-and-cutting die 3 mounted is then bolted to the screw die bracket 22 with bolt 231.

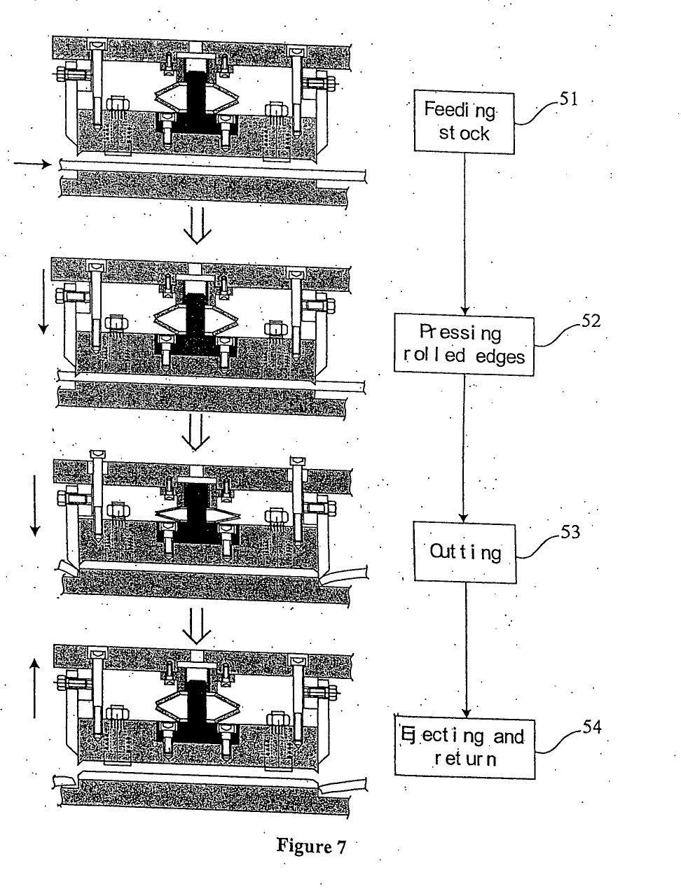

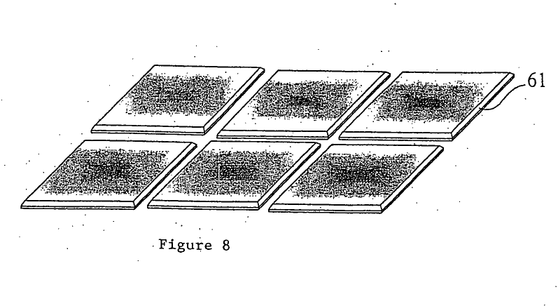

The forming-and-cutting method and process for producing vinyl tile with rolled edges of this invention are shown in FIG. 7. There are four major steps: (1) Feeding stock 51, uncut vinyl tile that has been rolled and embossed is positioned on the lower die 41 of the press. (2) Pressing rolled edges 52, the piston rod 21 of the hydraulic cylinder driven by the hydraulic system push the upper die base plate 23 and the press forming die 33 downward such that the triangular protruding slope of the press forming die 33 first touches the vinyl tile stock and forms the desired size and slopes of rolled edges. At this time, the ejector 336 on the press forming die 33 is compressed. (3) Cutting 53, as the hydraulic cylinder continues pushing downward, the press forming die 33 finally touches the vinyl tile stock and the disk spring 35 that can sustain the designed force is compressed, thus keeping the press forming die 33 still. The blade 32 presses downward relative to the press forming die 33 to cut the vinyl tile with rolled edges to size the blade 32 and lower die 41 are designed to produce. (4)

Ejecting and returning, raising the piston rod 21 of the hydraulic cylinder to lift the press forming die 33 and return it to its original position. At the same time, the cut vinyl tile is separated from the press forming die 33 by the ejection of the ejector 336 of the press forming die 33. Thus the end product of the vinyl tile with rolled edges 61, as shown in FIG. 8, is produced.

In sum, the forming-and-cutting method and device for vinyl tile with rolled edges in accordance with the present invention can effectively press and directly cut out the vinyl tile with rolled edges in a single integrated operation, thus improving upon the conventional two-stage manufacturing methods and devices that require more time and labor.

What is claimed is:

1. A forming-and-cutting method and device for producing vinyl tile with rolled edges comprising:
a press forming-and-cutting die having a press forming die which protrudes from a blade, and edges of the press forming die having an outward-tilted protruding triangular slope; and
the press forming die protruding from the blade thereby enabling a process of forming rolled edges and cutting in single piston stroke.

2. The forming-and-cutting method and device for producing vinyl tile with rolled edges claimed in claim 1, wherein four sets of ejectors are respectively embedded in the spot-faced holes drilled at the four corners of the press forming die, thus separating the vinyl tile from the press forming die after forming and cutting, and the four-member ejector can be replaced by six-member or eight-member ejector.

3. The forming-and-cutting method and device for producing vinyl tile with rolled edges claimed in claim 1, wherein a linear bearing is mounted in the center of the press forming die, thus ensuring the steady vertical movement of the press forming die, and the round bar is screwed to the press forming die and the sliding block of the linear bearing is screwed to the upper die base plate, or vice versa.

4. The forming-and-cutting method and device for producing vinyl tile with rolled edges claimed in claim 1, wherein a disk spring based on the press force needed for pressing the rolled edges is mounted on the linear bearing, wherein the disk spring can be replaced by other types of springs.

5. The forming-and-cutting and device for producing vinyl tile with rolled edges claimed in claim 1, wherein a blade has a triangular protruding slope at the edges of the press forming die, wherein the triangular slope can be replaced by other geometric shapes.

6. The forming-and-cutting method and device for producing vinyl tile with rolled edges claimed in claim 1, wherein four bolts are respectively put through four spot-faced holes of the upper die base plate to let the press forming die hang under the upper die base plate, thus enabling the vertical movement of the press forming die relative to the blade and the upper die base plate.

7. A forming-and-cutting method for producing vinyl tile with rolled edges in a single integrated operation comprising the steps of:
feeding uncut vinyl tile which has been rolled and embossed into position onto a lower die of a press,
pushing at least one press forming die having sloping edges from an initial position into operative engagement with the uncut vinyl stock, operative engagement being at least partially defined by the press forming die forming a plurality of rolled edges in the uncut vinyl tile stock,
cutting the uncut tile stock around the periphery of the at least one press forming die while maintaining the press forming die in operative engagement with the uncut vinyl tile stock,
ejecting at least one cut vinyl tile has rolled edges from the press forming die, and
returning the press forming die to its initial position.
